(19) United States
(12) Patent Application Publication
(10) Pub. No.: US 2005/0234859 A1
(43) Pub. Date: Oct. 20, 2005

(54) Information processing apparatus, resource managing apparatus, attribute modifiability judging method, and computer-readable storage medium

(76) Inventor: Jun Ebata, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/094,694

(22) Filed: Mar. 31, 2005

(30) Foreign Application Priority Data
Apr. 2, 2004 (JP) 2004-110001
Feb. 14, 2005 (JP) 2005-036301

(51) Int. Cl. G06F 7/00

(52) U.S. Cl. 707/1

(57) ABSTRACT

An information processing apparatus includes a judging part to judge a modifiability of a value of an attribute of a resource that is an access target based on definition information. The definition information defines a rule related to the modifiability of the value of the attribute is to be permitted depending on a combination of a value prior to the modification and a value after the modification, for the value of the attribute of the resource that is the access target.

### BACKGROUND OF THE INVENTION

1. Field of the Invention

The present invention generally relates to information processing apparatuses, resource managing apparatuses, attribute modifiability judging methods and computer-readable storage media, and more particularly to an information processing apparatus, a resource managing apparatus, an attribute modifiability judging method and a computer-readable storage medium for controlling attribute modifiability of an electronic resource, that is, for controlling whether or not an attribute value of the electronic resource can be modified.

2. Description of the Related Art

As a means of controlling access to a document in a document managing system, it is possible to manage a security rule that indicates the operations that are permitted by each user, by providing an operation permission list called an Access Control List (ACL) for each document or for each set of a plurality of documents.

According to the access control based on the ACL, it is possible to modify the security rule with respect to an arbitrary document by editing the ACL with respect to this arbitrary document. Accordingly, it is possible to prevent unauthorized modification of the security rule by providing editing rights with respect to the ACL. In this case, the editing rights are only categorized into two kinds, namely, “a person who cannot modify the ACL” and “a person who can freely modify the ACL”.

On the other hand, in order to maintain consistency of the access control not only within one system but with respect to the resources such as documents in a wider range, there is a proposed system that summarizes information related to the access control (hereinafter simply referred to as “access control information”) of a plurality of systems in a single security server, and in which each application that utilizes the resources judges whether or not various kinds of operations with respect to the resources are permitted based on a coherent access control policy (or security policy).

In this case, since the target operation to be controlled differs depending on the application, management information becomes complex if the access control information of the plurality of systems is simply summarized. Accordingly, in the security server, it is necessary to define a security policy having a higher abstraction, and when making each individual judgement in particular, it is necessary to carry out the access control by referring to a most appropriate policy description for each application of the policy descriptions that are defined for each abstract operation. For example, whether or not the execution of the process is permitted is judged based on a “document output rule” policy, for a “print output” process and a “downloading to a local personal computer” process, as described in a Japanese Laid-Open Patent Application No. 2003-150751.

However, in general, the security policy categorizes the resources based on the attributes of the resources, and defines the security rule for each category. For this reason, a modification of the attribute value of a reference attribute for the categorization (hereinafter simply referred to as a “security attribute”) has the effect of modifying the security rule with respect to the resource. Consequently, according to the conventional access control, there was a problem in that, even a user who does not have an editing right with respect to the ACL can modify the security rule of the resource if this user is permitted to modify the attribute value of the attribute of the resource.

### SUMMARY OF THE INVENTION

Accordingly, it is a general object of the present invention to provide a novel and useful information processing apparatus, resource managing apparatus, attribute modifiability judging method and computer-readable storage medium, in which the problems described above are suppressed.

Another and more specific object of the present invention is to provide an information processing apparatus, a resource managing apparatus, an attribute modifiability judging method and a computer-readable storage medium, which can appropriately control a modification of an attribute value of a resource that is an access target.

Still another and more specific object of the present invention is to provide an information processing apparatus comprising a judging part configured to judge a modifiability of a value of an attribute of a resource that is an access target, based on definition information, where the definition information defines a rule related to the modifiability of the value of the attribute is to be permitted depending on a combination of a value prior to the modification and a value after the modification, for the value of the attribute of the resource that is the access target. According to the information processing apparatus of the present invention, it is possible to appropriately control the modification of the attribute value of the resource that is the access target.

A further object of the present invention is to provide a resource managing apparatus for managing a resource that becomes an access target, comprising a part configured to send the request that requests judging the modifiability of the attribute of the resource that is the access target, with respect to the information processing apparatus described above; and a part configured to judge the modifiability of the value of the attribute of the resource that is the access target, based on the judgement result that is returned from the information processing apparatus in response to the request. According to the resource managing apparatus of the present invention, it is possible to appropriately control the modification of the attribute value of the resource that is the access target.

Another object of the present invention is to provide an attribute modifiability judging method to be implemented by a computer, comprising a judgement request accepting procedure accepting a request that requests judging a modifiability of a value of an attribute of a resource that is an access target; a definition information acquiring procedure acquiring definition information that defines rules related to judging the modifiability of the value of the attributes of the resources that may become the access target depending on a combination of a value prior to the modification and a value after the modification of the attribute of the resource that is the access target; a rule selecting procedure selecting the rule corresponding to the request that requests judging the modifiability of the value of the attribute of the resource that is the access target, of the rules defined in the definition information acquired by the definition information acquiring procedure; and a judging procedure judging the modifiability of the value of the attribute by applying the rule selected by the rule selecting procedure. According to the attribute modifiability judging method of the present invention, it is possible to appropriately control the modification of the attribute value of the resource that is the access target.

Still another object of the present invention is to provide a computer-readable storage medium which stores a program for causing a computer to judge modifiability of an attribute, the program comprising a judgement request accepting procedure causing the computer to accept a request that requests judging a modifiability of a value of an attribute of a resource that is an access target; a definition information acquiring procedure causing the computer to acquire definition information that defines rules related to judging the modifiability of the value of the attributes of the resources that may become the access target depending on a combination of a value prior to the modification and a value after the modification of the attribute of the resource that is the access target; a rule selecting procedure causing the computer to select the rule corresponding to the request that requests judging the modifiability of the value of the attribute of the resource that is the access target, of the rules defined in the definition information acquired by the definition information acquiring procedure; and a judging procedure causing the computer to judge the modifiability of the value of the attribute by applying the rule selected by the rule selecting procedure. According to the computer-readable storage medium of the present invention, it is possible to appropriately control the modification of the attribute value of the resource that is the access target.

Other objects and further features of the present invention will be apparent from the following detailed description when read in conjunction with the accompanying drawings.

### BRIEF DESCRIPTION OF THE DRAWINGS

FIG. 1 is a system block diagram showing a structure of a document managing system in an embodiment of the present invention;

FIG. 2 is a diagram showing a structure of a document profile;

FIG. 3 is a system block diagram showing a hardware structure of a security server in the embodiment of the present invention;

FIG. 4 is a diagram generally showing a definition of a document policy;

FIG. 5 is a diagram for explaining a security rule that is applied to the embodiment of the present invention when modifying the value of a security attribute;

FIG. 6 is a diagram showing a first definition of an attribute modifying policy;

FIG. 7 is a diagram generally showing a definition content in FIG. 6;

FIG. 8 is a diagram showing a second definition of the attribute modifying policy;

FIG. 9 is a sequence diagram for generally explaining a process when a modification of a security attribute is requested;

FIG. 10 is a flow chart for explaining a process of modifying the value of the security attribute in a document profile service;

FIG. 11 is a diagram showing a structure of an attribute correspondence table;

FIG. 12 is a flow chart for explaining a process of judging a modifiability of the value of the security attribute is permitted in a security service; and

FIG. 13 is a system block diagram showing a structure of an equipment implemented with various kinds of services of the embodiment of the present invention.

### DESCRIPTION OF THE PREFERRED EMBODIMENTS

A description will be given of embodiments of an information processing apparatus, a resource managing apparatus, an attribute modifiability judging method and a computer-readable storage medium according to the present invention, by referring to the drawings.

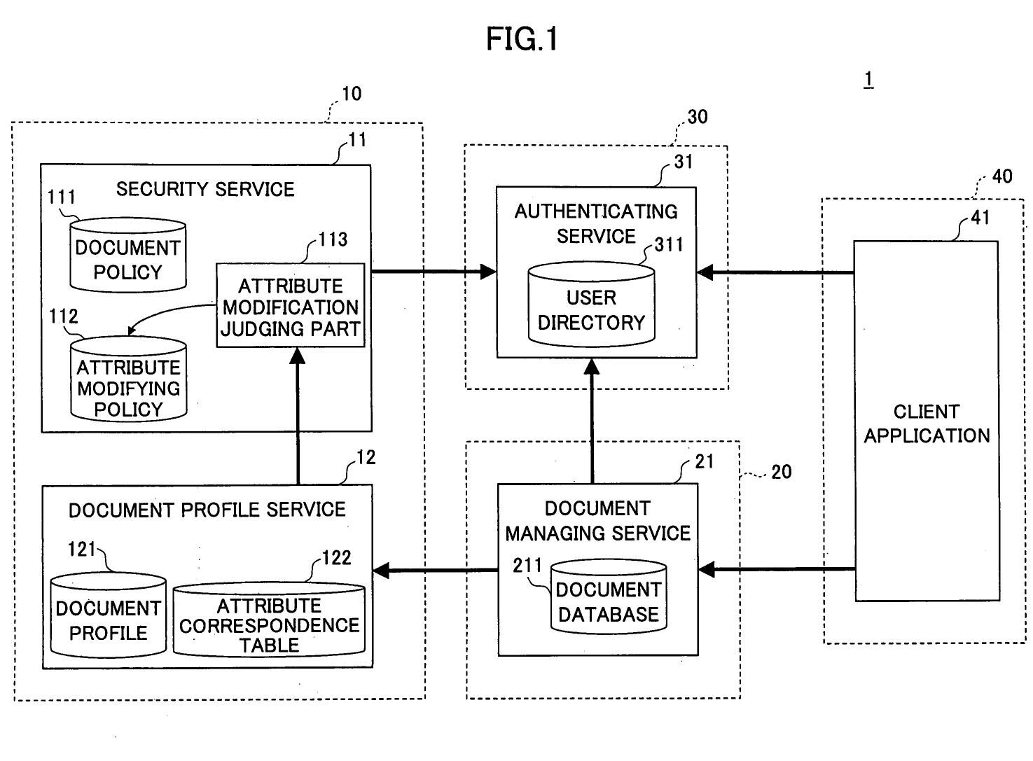

FIG. 1 is a system block diagram showing a structure of a document managing system in an embodiment of the present invention. A document processing system 1 shown in FIG. 1 is formed by computers such as a security server 10, a document managing server 20, an authentication server 30 and a client apparatus 40 that are connected via one or more networks such as a Local Area Network (LAN) and the Internet.

The security server 10 is implemented with a security service 11, a document profile service 12 and the like. The security service 11 is formed by a software that provides, as Web services, a function of judging whether or not to permit various kinds of operations with respect to documents managed in the document managing server 20, based on a document policy 111 and the like, together with managing functions such as the document policy 111 and an attribute modifying policy 112. In other words, the security service 11 is formed by the document policy 111, the attribute modifying policy 112, an attribute modification judging part 113 and the like.

The document policy 111 is a file in which security rules related to various operations (referring printing and the like) with respect to the documents are defined. In the document policy 111, the documents are categorized based on attribute values of a portion of the document attributes, and the security details are defined according to the categories. Of the document attributes, the attribute that is used as a reference to categorize the documents in the definition of the security rules will hereinafter be referred to as a “security attribute”. The security attribute is not limited to one, and a plurality of attributes may simultaneously become the security attributes.

The attribute modifying policy 112 is a file in which the security rules with respect to the modification of the value of the security attribute is defined. The attribute modification judging part 113 is a module that judges whether or not the modification of the value of an arbitrary security attribute is permitted, based on the attribute modifying policy 112. The details of the document policy 111 and the attribute modifying policy 112 will be described later in the specification.

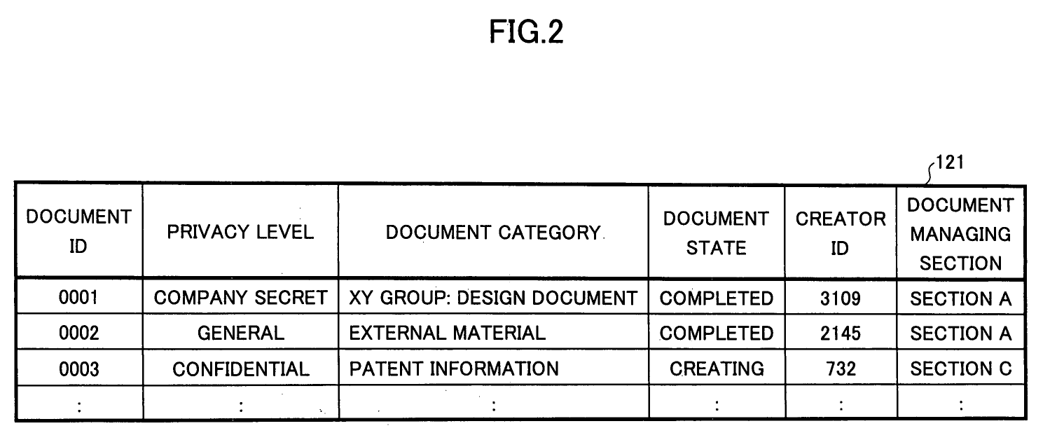

The document profile service 12 is formed by a software that provides, as Web services, managing functions of the document profile 121, and includes the document profile 121, the attribute correspondence table 122 and the like. FIG. 2 is a diagram showing a structure of the document profile 121. As shown in FIG. 2, the document profile 121 is a table for managing only the security attributes, of the document attributes managed in a document database 211 of the document managing service 21. FIG. 2 shows a case where a privacy level, a document category, a document state, a creator identification (ID) and a document managing section (or department) are selected in the document profile 121 as the security attributes. Accordingly, the security attributes of each document are managed in double, that is, in both the document database 211 and the document profile 121. The document profile service 12 also provides a function of a mediator between the document managing service 21 and the security service 11 based on the attribute correspondence table 122. The details of the attribute correspondence table 122 will be described later in the specification.

The document managing server 20 shown in FIG. 1 is implemented with the document managing service 21. The document managing service 21 is formed by a software that provides, as Web services, a function of managing documents (document files, attribute information and the like) managed in the document database 211. In this embodiment, the document managed in the document database 211 is used as an example of a resource that is the access target.

The authentication server 30 is implemented with an authenticating service 31. The authenticating service 31 is formed by a software that provides, as Web services, a function of authenticating the user of the document managing system 1. The authenticating service 31 authenticates the user according to an authentication request, and when the user is authenticated, issues an electronic certificate (hereinafter referred to as a “ticket”) which certifies that the user has been authenticated.

The client apparatus 40 is implemented with a client application 41. The client application 41 utilizes the various server functions described above. The client apparatus 40 is not limited to a terminal that is used directly by an end user. For example, the client apparatus 40 may be a Web server, and in this case, the application implemented in the client apparatus 40 corresponds to a Web application.

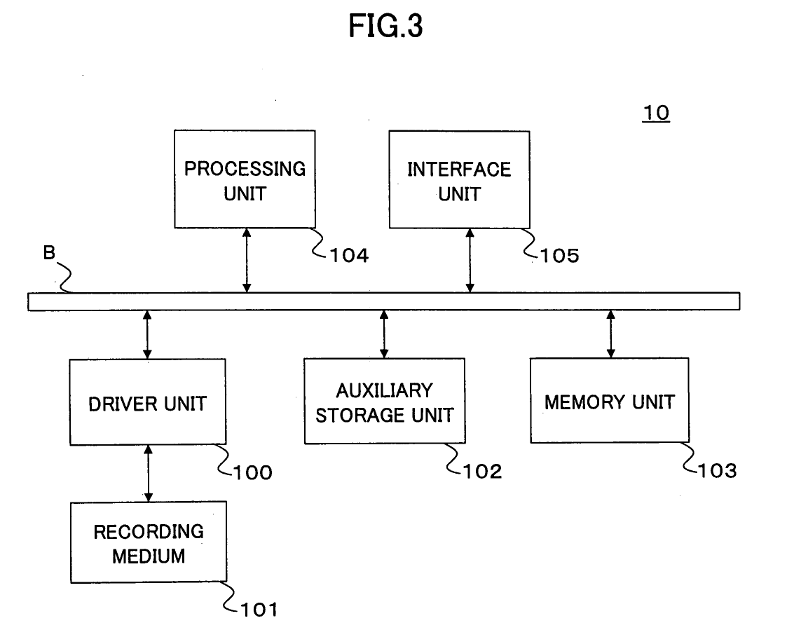

Next, a more detailed description will be given of the security server 10. FIG. 3 is a system block diagram showing a hardware structure of the security server 10 in this embodiment of the present invention. The security server 10 shown in FIG. 3 includes a driver unit 100, an auxiliary storage unit 102, a memory unit 103, a processing unit 104 and an interface unit 105 that are connected via a bus B.

One or more programs for realizing processes in the security server 10 are provided by a recording medium 101 such as a CD-ROM. When the recording medium 101 that stores the program is loaded into the driver unit 100, the program is installed into the auxiliary storage unit 102 from the recording medium 101 via the driver unit 100. The auxiliary storage unit 102 stores the installed program, and other necessary files and data.

The memory unit 103 reads the program from the auxiliary storage unit 102 and stores the read program in response to a program start instruction. The processing unit 104 executes the program stored in the memory unit 103 to execute the functions related to the security server 10. For example, the interface unit 105 is formed by a modem, a router or the like, and is used to connect the security server 10 to a network.

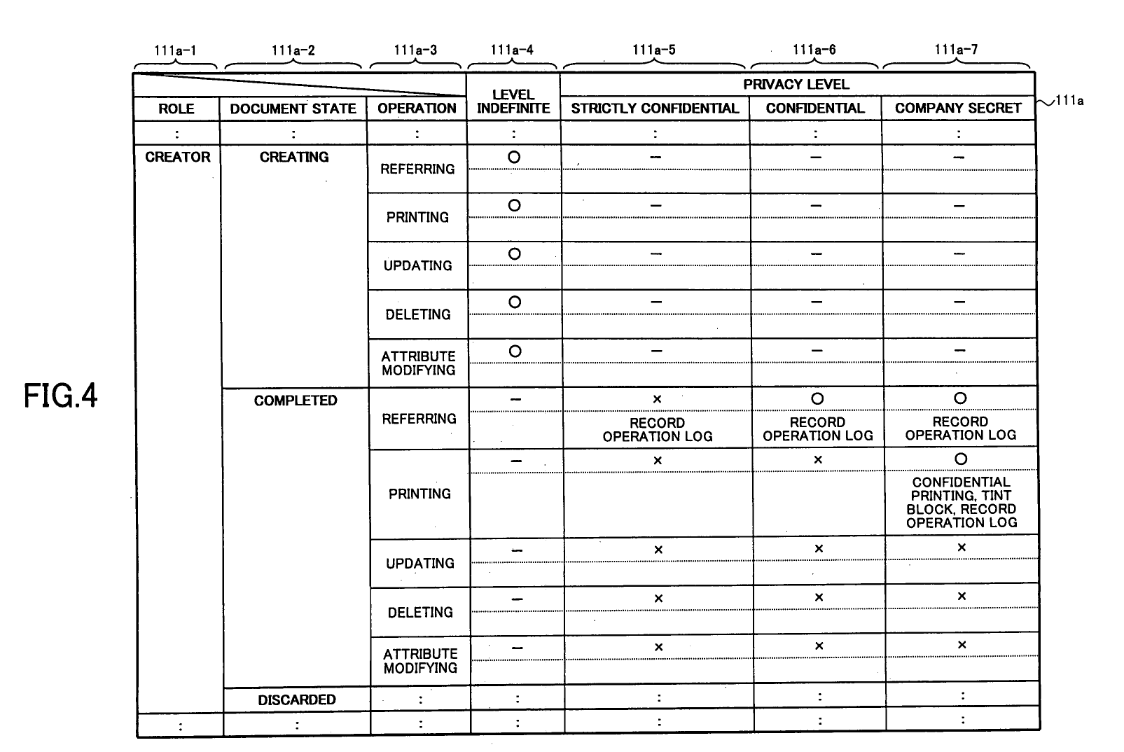

Next, a more detailed description will be given of the document policy 111 and the attribute modifying policy 112 shown in FIG. 1. FIG. 4 is a diagram generally showing a definition of the document policy 111. FIG. 4 shows a table 111a in which the documents are categorized according to roles of identities (users) who operate on the documents, and the documents are categorized by a combination of 2 security attributes (document state and privacy level), so that whether or not the various operations are permitted are defined depending on the combination.

For example, the identifies include “creator”, “participant”, “officer”, “manager” and “other than participants”. The “creator” is the user who created the document, and is set for each document. The “participant” is the user who has the legitimate right to operation on the document, and is managed by a list of participants defined for each document. The “officer” is the user who is responsible for the management of the document state and the privacy level of the documents, and performs operations such as approving the document, determining the privacy level and determining the discarding (or canceling) of the privacy level. The “manager” is the user who globally manages the documents and operates the document managing system 1. The “other than participants” is the user who does not fall in the categories “creator”, “participant”, “officer” and “manager”, but who may become the user of the document managing system 1. In the table 111a, the role of the identity is specified by the value in a column 111a-1. Only the definitions with respect to the creator are shown in FIG. 4 for the sake of convenience, but similar definitions are of course made with respect to the other roles.

The document state indicates a state in a life cycle of the document, such as “creating”, “completed” and “discarded”. The “creating” state indicates the state of the document that is being created and prior to completion or approval. With respect to the document in the “creating” state, the main rights are given to the creator. The “completed” state indicates the state of the document as a formal document, such as after the document is approved by the officer. With respect to the document in the “completed” state, the main rights are given to the manager, and the rights of inspection, updating and the like are given to the participant. The “discarded” state indicates the state of the document that has become invalid due to an expiry of a term, for example. In the table 111a, the document state is specified by the value in a column 111a-2.

The privacy level includes strictly confidential, confidential, company secret and the like. The privacy level of the “creating” document, that is, the document that is being created, is not yet definite. In the table 111a, each operation that is permitted is indicated by a symbol “O” and each operation that is not permitted (or prohibited) is indicated by a symbol “X” for each of the privacy levels in columns 111a-4 through 111a-7. The duty when performing the operation is indicated below the symbols “O” and “X” where applicable.

The operation includes referring, printing, updating, deleting, attribute modifying and the like. In the table 111a, the operation is specified by the value in a column 111a-3.

Therefore, the creator can perform the operation such as referring, printing, updating, deleting and attribute modifying with respect to the document that is in the “creating” state and has a privacy level tat is not yet definite. But when the document is completed and the privacy level is defined (or set), the creator is not permitted to perform any operation with respect to the strictly confidential document, permitted to only refer to the confidential document, and permitted to only refer and print the company secret document. However, an operation log needs to be recorded when referring to the confidential document and the company secret document, and the duty to perform a confidential printing is indicated when printing the company secret document. FIG. 4 generally shows the definition of the document policy 111 in the form of the table 111a, but it is of course possible to define the document policy 111 in the extensible Access Control Markup Language (XACML) when including the document policy 111 in the security service 11.

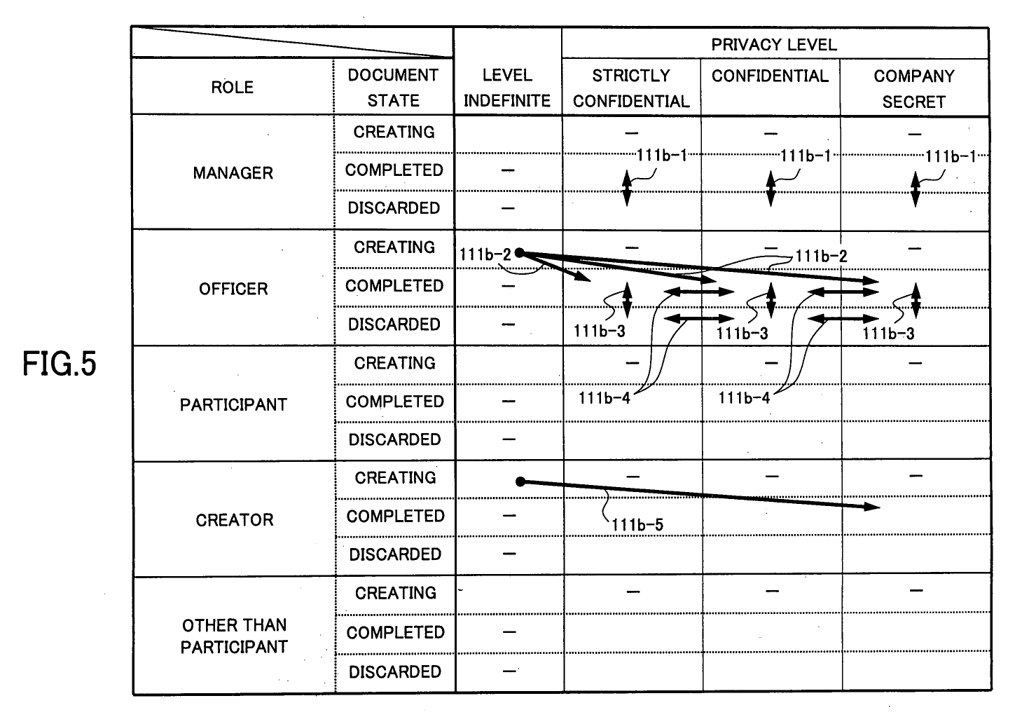

As may be seen from the table 111a, the modification of the value of the security attribute such as the document state and the privacy level causes a modification in the security rule that is applied with respect to the document. In other words, when the document that is being created is changed into a completed document or, when a confidential document is changed into a strictly confidential document, for example, the operations that are permitted with respect to the document changes. In addition, depending on the manner in which a particular value of a particular security attribute is changed, the effects on the security rule that is applied with respect to the document changes. Hence, with regard to the security attribute, it is desirable that whether or not the modification of the value of the security attribute is to be permitted (that is, whether or not the value of the security attribute is modifiable) is controllable for each security attribute. In this embodiment, it is assumed that a control shown in FIG. 5 is to be made.

FIG. 5 is a diagram for explaining the security rule that is applied to this embodiment of the present invention when modifying the value of the security attribute. In FIG. 5, arrows 111b-1 indicate operations that are permitted to the manager. It may be seen from the arrows 111b-1, the manager is permitted to modify a completed document into a discarded document and to modify a discarded document into a completed document, with respect to each of the strictly confidential document, the confidential document and the company secret document. However, the manager is not permitted to modify the privacy level.

Arrows 111b-2 through 111b-4 indicate operations permitted to the officer. It may be seen from the arrows 111b-2 that the officer is permitted to complete the document that is being created into a strictly confidential document, a confidential document or a company secret document. The significance of “completed” may be defined for each application, but in the case of the document managing system 1, “completed” may be an operation of approving the document, for example. It may be seen from the arrows 111b-3 that the officer is permitted to perform the same operations as the manager. Furthermore, it may be seen from the arrows 111b-4 that the officer is permitted to modify the privacy level.

An arrow 111b-5 indicates an operation permitted to the creator. It may be seen from the arrow 111b-5 that the creator is only permitted complete the document that is being created into a company secret document.

No arrows are shown in FIG. 5 for the participant and other than the participant. Hence, it may be seen that the participant and other than the participant are not permitted to perform any operation related to the modification of the value of the security attribute.

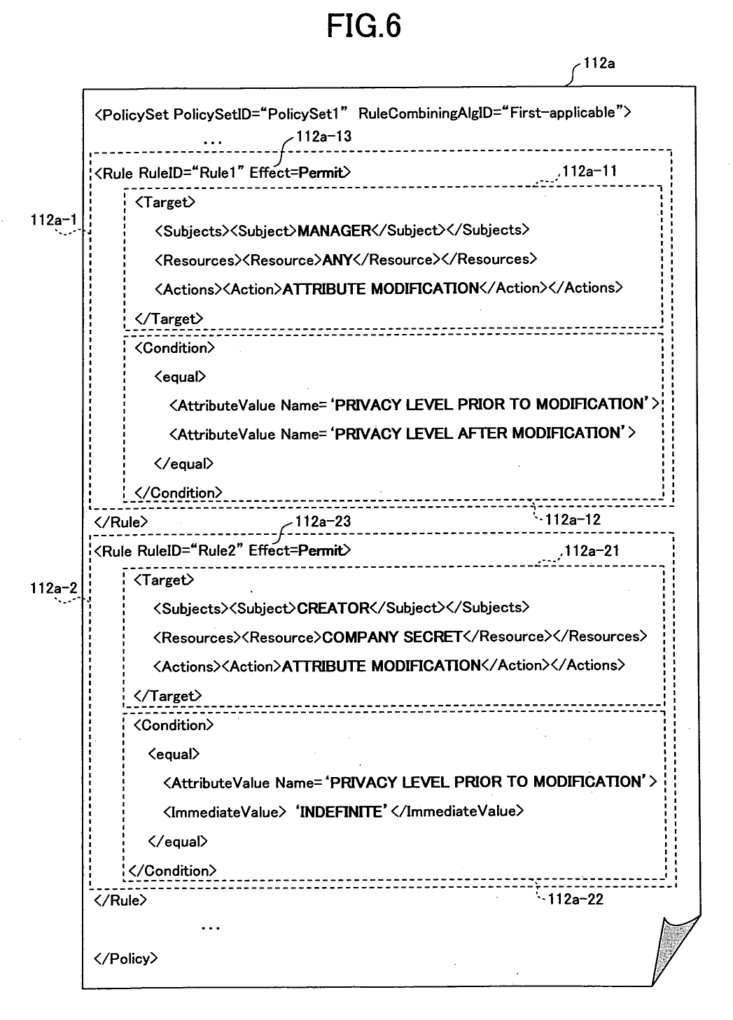

The security rule with respect to the modification of the value of the security attribute generally shown in FIG. 5 is actually defined in the attribute modifying policy 112. An example of the contents of the definition of the security rule is shown in FIG. 6.

FIG. 6 is a diagram showing a first definition of the attribute modifying policy. FIG. 6 show a case where the security rule is defined by referring to the XACML specification. In an attribute modifying policy 112a shown in FIG. 6, the security rule with respect to the modification of the value of the security attribute is defined for each of Rule definitions 112a-1 and 112a-2 that is surrounded by <Rule> tags. Each <Rule> tag is added with an Effect attribute, and the value (Permit or Deny) of the Effect attribute indicates a judgement result (whether or not the modification is permitted) for the case where the security rule is decided as the application target when judging the modifiability of the value of the security attribute is permitted.

Each Rule definition includes a Target definition surrounded by <Target> tags, and a Condition definition surrounded by <Condition> tags.

A Target definition is used to specify the target (identity, resource and action) to which the security rule is applied, and the identity, resource and action are specified by a Subject definition, a Resource definition, an Action definition and the like. In this embodiment, the document corresponds to the resource, the operation of modifying the attribute corresponds to the action. In addition, the identity is specified by the role, and the document is specified by the value of the security attribute (document state and privacy level).

A Condition definition defines a conditional expression or equation for judging the application of the security rule.

Next, a description will be given of the definition contents of the attribute modifying policy 112a, based on the above. The Rule definition 112a-1 includes a Target definition 112a-11 and a Condition definition 112a-12. From the Condition definition 112a-11, it may be seen that the identity, the document and the-operation to which the security rule is applied respectively are the manager, any document (that is, document having any document state and any privacy level) and the modification of the attribute value. In the Target definition shown in FIG. 6, the document is specified by the attribute value after the modification that is the target of the judgement to determine whether or not the modification is permitted (that is, to determine the modifiability).

From the Condition definition 112a-12, it may be seen that the condition for applying the security rule is that the privacy level prior to the modification and the privacy level after the modification are equal. The condition “when equal” may be derived from parameters for judging the condition that are surrounded by <equal> tags. Furthermore, since the value of an Effect attribute 112a-13 of the Rule definition 112a-1 is “Permit”, it may be seen that the judgement result for the case where the security rule is applied is “ipermit”.

Accordingly, from the Rule definition 112a-1, it is possible to derive “If the privacy level prior to the modification and the privacy level after the modification are equal, the manager is permitted to modify the value of the security attribute to an arbitrary (ANY) value”. This corresponds to the arrow 111b-1 shown in FIG. 5.

On the other hand, the Rule definition 112a-2 includes a Target definition 112a-21 and a Condition definition 112a-22. From the Condition definition 112a-21, it may be seen that the identity, the document and the operation to which the security rule is applied respectively are the creator, the company secret (privacy level after the modification) and the modification of the attribute value. In addition, from the Condition definition 112a-22, it may be seen that the condition for applying the security rule is that the privacy level prior to the modification is not yet defined. Moreover, since the value of an Effect attribute 112a-23 of the Rule definition 112a-2 is “Permit”, it may be seen that the judgement result for the case where the security rule is applied is “permit”.

Therefore, from the Rule definition 112a-2, it is possible to derive “The creator is permitted to modify a document having an undefined privacy level into a company secret document having the company secret as the privacy level”. This corresponds to the arrow 111b-5 shown in FIG. 5.

The definitions with respect to the officer and the like may be made similarly, but the illustration thereof is omitted in FIG. 6 for the sake of convenience.

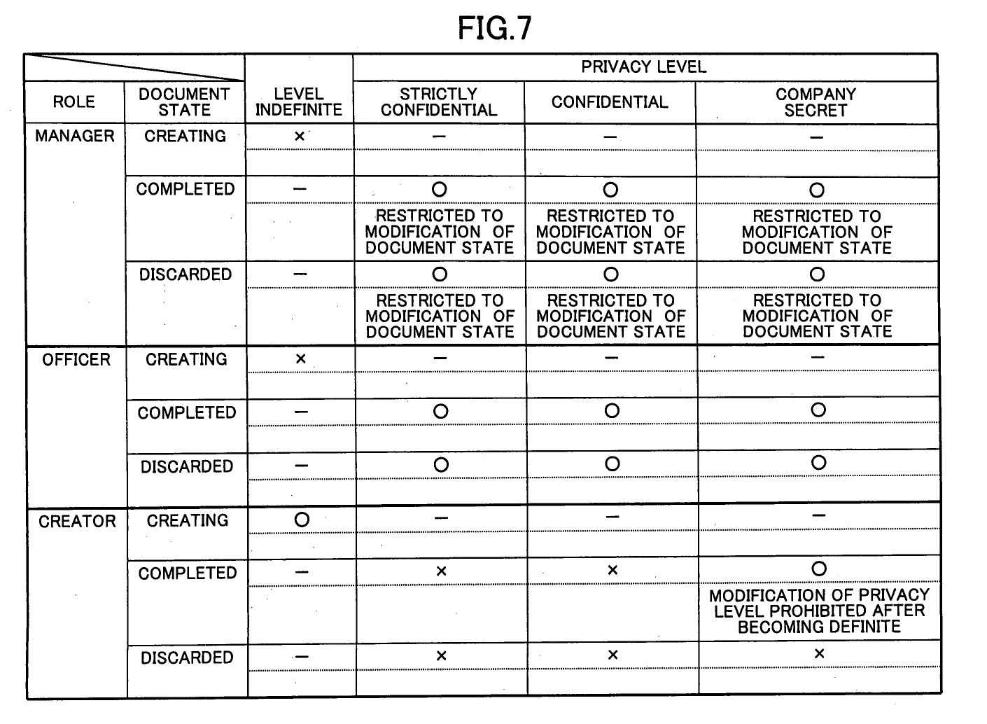

FIG. 7 is a diagram generally showing the definition content in FIG. 6. In FIG. 7, a symbol “O” indicates the case where the modification of the value of the security attribute to a corresponding value is permitted. For example, with respect to the manager, it is indicated in FIG. 7 that each of the strictly confidential document, the confidential document and the company secret document may be modified into the completed document and into the discarded document. But in these cases, the condition “restricted to modification of the document state” is added. This indicates that the modification of the privacy level is not permitted, and corresponds to the condition “If the privacy level prior to the modification and the privacy level after the modification are equal” in FIG. 6.

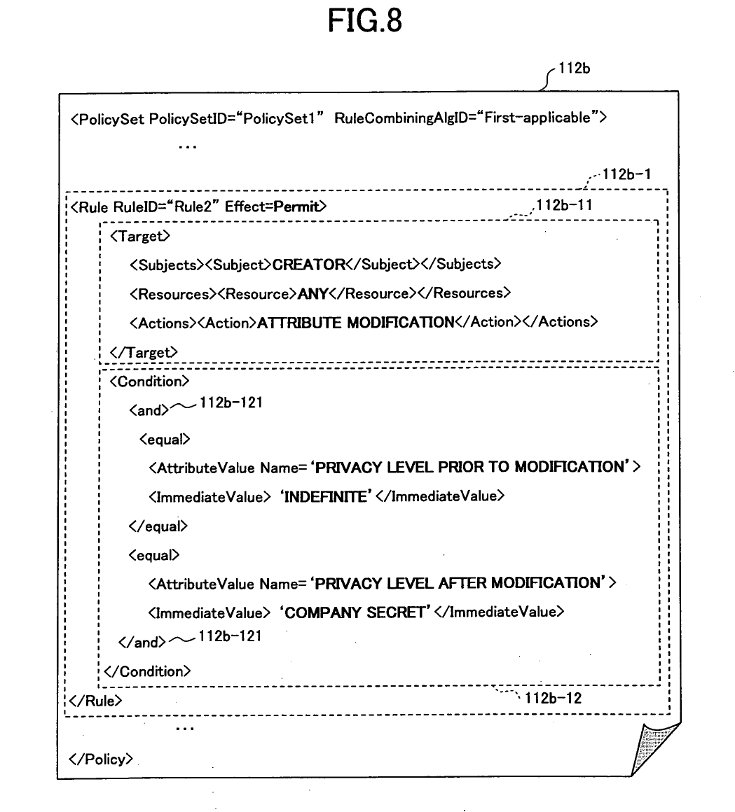

The definition of the attribute modifying policy 111 may be made as shown in FIG. 8. FIG. 8 is a diagram showing a second definition of the attribute modifying policy 111. An attribute modifying policy 112b shown in FIG. 8 is formed one or more Rule definitions including the Target definition, the Condition definition and the like, and otherwise has a structure similar to that of the attribute modifying policy 112a shown in FIG. 6, except for the method of description. However, the contents defined in a Rule definition 112b-1 are the same as those defined in the Rule definition 112a-2 shown in FIG. 6.

In other words, in FIG. 8, the document in a Target definition 112b-11 is specified by the value of the security attribute prior to the modification. In addition, it is a condition in a Condition definition 112b-12 that “The privacy level prior to the modification is not yet defined, and the privacy level after the modification is the company secret”. The condition “and” is derived since each conditional expression or equation surrounded by the <equal> tags is surrounded by <and> tags 112b-121. Accordingly, it is defined in the Rule definition 112b-1 that “The creator is permitted to modify a document having an undefined privacy level into a company secret document having the company secret as the privacy level”. This corresponds to the arrow 111b-5 shown in FIG. 5, similarly to the case of the Rule definition 112a-2.

Therefore, although various methods of description may be employed for the attribute modifying policy 111 and the particular representation formats may differ, the security rule is always defined depending on the combination of the values of the security attribute prior to and after the modification and depending on the role of the identity.

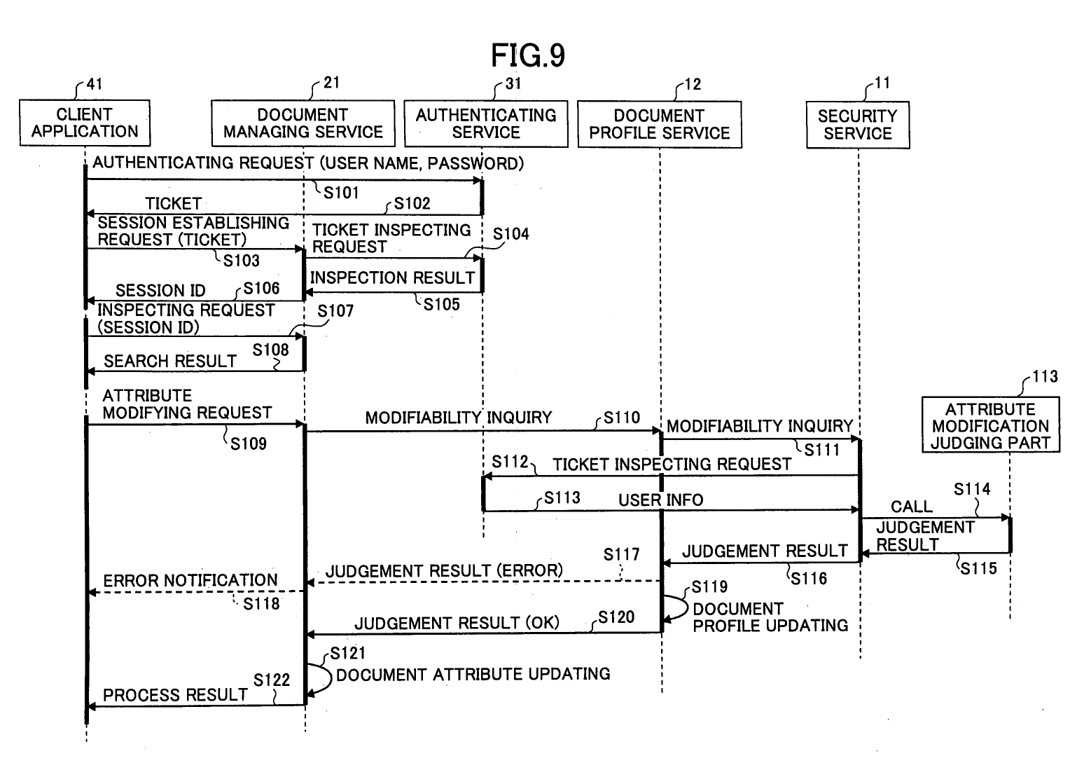

Next, a description will be given of a processing procedure of the document managing system 1 when a modification of an arbitrary security attribute is requested with respect to an arbitrary document. FIG. 9 is a sequence diagram for generally explaining the process when the modification of the security attribute is requested.

In FIG. 9, steps S101 through S108 correspond to the modification of the security attribute of the document, and form a preprocess (establishing a session, searching a document, and the like). In other words, based on a log-in instruction from the user, the client application 41 requests a user authentication with respect to the authenticating service 31 using a user name and a password as arguments (step S101). The authenticating service 31 authenticates the user, and generates a ticket certifying the user if the user is authenticated. For example, the ticket is recorded with a ticket ID for identifying the ticket, a valid range indicting services for which the ticket is valid, a valid term indicating a valid term in which the services may be utilized by the ticket, a user ID, a tampering check code and the like. The contents of the ticket are enciphered so that the contents may only be referred to by the authenticating service 31, and sent to the client application 41 (step S102).

The client application 41 sends a session establishing request to the document managing service 21 using the ticket as an argument (step S103). The document managing service 21 requests a validity inspection of the received ticket to the authenticating service 31 (step S104), and if an inspection result indicating that the ticket is valid is returned (step S105), returns a session ID with respect to the client application 41 (step S106). The document managing service 21 stores the user's ticket in relation to the session ID.

When the user makes a document search request after the session is established, the client application 41 sends the document search request to the document managing service 21 using the session ID, a search condition and the like as arguments (step S107). The document managing service 21 searches for the document based on the search condition, and sends a search result to the client application 41 (step S108).

At this point in time, a list of the searched documents is provided (displayed) on a document list screen at the user. Hence, when the user performs operations such as selecting an arbitrary document and requiring modification of the security attribute of the selected document (hereinafter referred to as a “current document”). The security attribute which is the target of the modification will hereinafter be referred to as a “target attribute”.

Based on the operation by the user, the client application 41 sends a target attribute modifying request with respect to the document managing service 21, using the session ID, a document ID of the current document, an attribute ID of the target attribute, the value of the target attribute after the modification and the like as arguments (step S109). After the step S109, the process advances to a step S110, and the document managing service 21 specifies the ticket with respect to the current user based on the session ID, and inquires the document profile service 12 the modifiability of the value of the target attribute, using the ticket, the document ID, the attribute ID of the target attribute, the value of the attribute after the modification and the like as arguments. The process advances to a step S111 after the step S110, and the document profile service 12 acquires the current values (prior to the modification) of all of the security attributes of the current document (hereinafter referred to as a “security attribute list”) from the document profile 121, and inquires the security service 11 the modifiability of the value of the target attribute, using the acquired security attribute list, the ticket, the attribute ID of the target attribute, the value of the attribute after the modification and the like as arguments.

The process advances to a step S112 after the step S111, and when the security service 11 requests a validity inspection of the ticket with respect to the authenticating service 31, the authenticating service 31 inspects the validity of the ticket, searches user information (user ID, group ID, section (or department) and the like) of the current user from a user directory 311, and returns the user information with respect to the security service 11 (step S113). The process advances to a step S114 after the step S113, and when the security service 11 calls the attribute modification judging part 113, the attribute modification judging part 113 judges the modifiability of the attribute value based on the security attribute list, the attribute ID of the target attribute, the value of the attribute after the modification and the attribute modifying policy 112, and outputs a judgement result with respect to the security service 11 (step S115). The security service 11 outputs the received judgment result with respect to the authenticating service 31 (step S116).

If the judgement result indicates that the modification of the value of the attribute is not permitted, the document profile service 12 sends to the document managing service 21 an error notification indicating that the value of the attribute cannot be modified (step S117). Based on the received error notification, the document managing service 21 sends an error notification with respect to the client application 41 (step S118).

On the other hand, if the judgement result indicates that the modification of the value of the attribute is permitted, the process advances to a step S119 after the step S116, and the document profile service 12 updates the value of the target attribute of the current document in the document profile 121 to the value after the modification. Then, the document profile service 12 sends the judgement result indicating that the modification of the value of the attribute is permitted with respect to the document managing service 21 (step S120). The process advances to a step S121 after the step S120, and the document managing service 21 updates the value of the target attribute of the current document in the document database 211 to the value after the modification, and sends a notification indicating that the modification of the value of the attribute is completed with respect to the client application 41 (step S122).

The value of the security attribute of the current document is modified by the above described process. Thereafter, an arbitrary operation (referring, printing, updating, deleting, attribute modifying and the like) with respect to the current document is requested from the client application 41, the access control is judged by applying the document policy 111 based on the value of the security attribute after the modification.

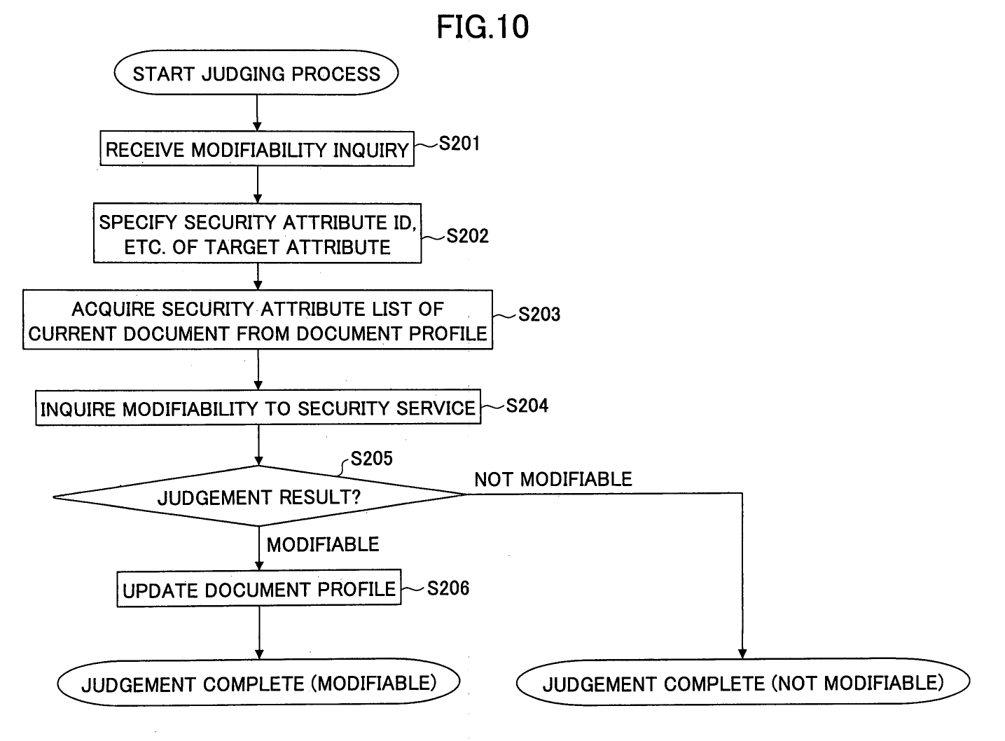

Next, a more detailed description will be given of the process (steps S110 through S120) shown in FIG. 9 that is carried out when the document profile service 12 receives the inquiry from the document managing service 21 inquiring the modifiability of the value of the target attribute. FIG. 10 is a flow chart for explaining the process of modifying the value of the security attribute in the document profile service 12.

In FIG. 10, a step S201 receives the inquiry from the document managing service 21 inquiring the modifiability of the value of the target attribute. As described above, this inquiry includes the ticket, the document ID, the attribute ID of the target attribute, the value of the attribute after the modification and the like as the arguments. The process advances to a step S202 after the step S201, and the attribute ID and the value of the attribute after the modification are converted based on the attribute correspondence table 122 into values that are interpretable (or analyzable) by the security service 11.

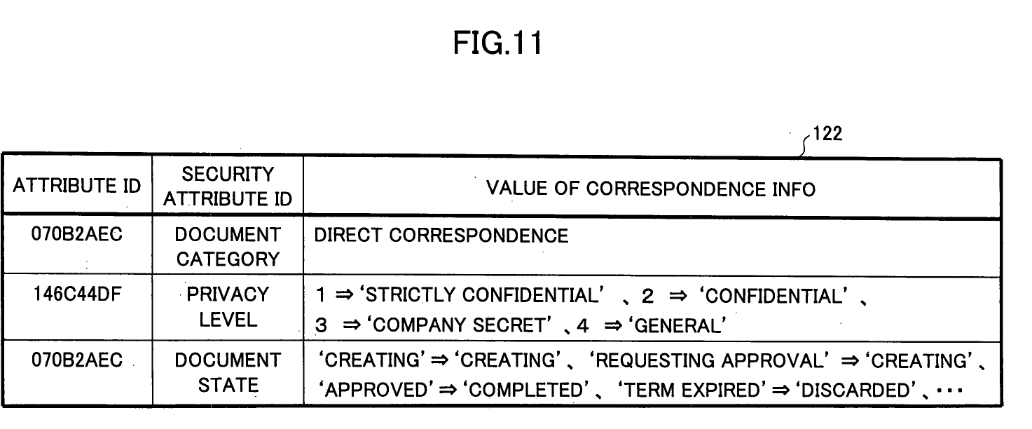

FIG. 11 is a diagram showing a structure of the attribute correspondence table 122. As shown in FIG. 11, the attribute correspondence table 122 includes items such as the attribute ID, the security attribute ID and the correspondence information of the value. The attribute ID is an ID that is uniquely assigned to each attribute for identifying the attribute in the document database 211. Hence, in the document managing service 21 and the client application 41, each attribute is identified by the attribute ID. The security attribute ID is an ID that is uniquely assigned to each attribute for identifying the attribute in document profile 121, the document policy 111 or the attribute modifying policy 112. Accordingly, in the document profile service 12 and the security service 11, each attribute is identified by the security attribute ID. The correspondence information of the value is mapping information indicating the correspondence between the values in the document database 211 and the values in the document profile 121, the document policy 111 and the attribute modifying policy 112. In a first row of the records in the attribute correspondence table 122, “direct correspondence” indicates that, for the concerned attribute, the value in the document database 211 and the value in the document profile 121 and the like are equal. In a second row of the records in the attribute correspondence table 122, it is indicated that, for the concerned attribute, values “1”, “2”, “3” and “4” in the document database 211 correspond to values “strictly confidential”, “confidential”, “company secret” and “general” in the document profile 121 and the like. A third row of the records in the attribute correspondence table 122 similarly indicate the mapping information.

The values of the attributes do not match between the document managing service 21 and the security service 11, because the security service 11 is not only used by the document managing service 21 but also by various other kinds of services that are not shown in FIG. 1, and it is necessary to manage the attribute information according to a more abstract concept.

Accordingly, if “146D44DF” is specified as the attribute ID in the inquiry that is received from the document managing service 21, for example, this attribute ID is converted into the “privacy level” as the security attribute ID, and if the value “1” of the attribute after the modification is specified, this value is converted into the “strictly confidential” privacy level. In the following description, the value of the attribute after the modification will be referred to as a “security attribute value”.

The process advances to a step S203 after the step S202, and the-values of the security attributes prior to the modification of the current document are acquired as the security attribute list from the document profile 121 shown in FIG. 2. For example, the “security level”, the “document category”, the “document state”, the “creator ID”, the “document managing section” and the like of the current document are acquired. The process advances to a step S204 after the step S203, and the inquiry is made with respect to the security service 11 to inquire the modifiability of the value of the target attribute, using the ticket, the security attribute list, the security attribute ID of the target attribute, the value of the security attribute after the modification and the like as the arguments.

The process advances to a step S205 after the step S204, and judges the modifiability of the value based on the judgement result that indicates the modifiability of the value of the target attribute, when the judgement result is received from the security service 11 in response to the inquiry made in the step S203. If it is judged that the modification of the value is permitted, the value of the target attribute of the current document in the document profile 121 is updated to the value of the security attribute after the modification, in a step S206. When the value of the target attribute is updated, the document profile service 12 sends with respect to the document managing service 21 the judgement result indicating that the modification of the value of the attribute is permitted. On the other hand, if it is judged that the modification of the value is permitted, the document profile service 12 sends with respect to the document managing service 21 the error notification indicating that the modification of the value of the attribute is not permitted.

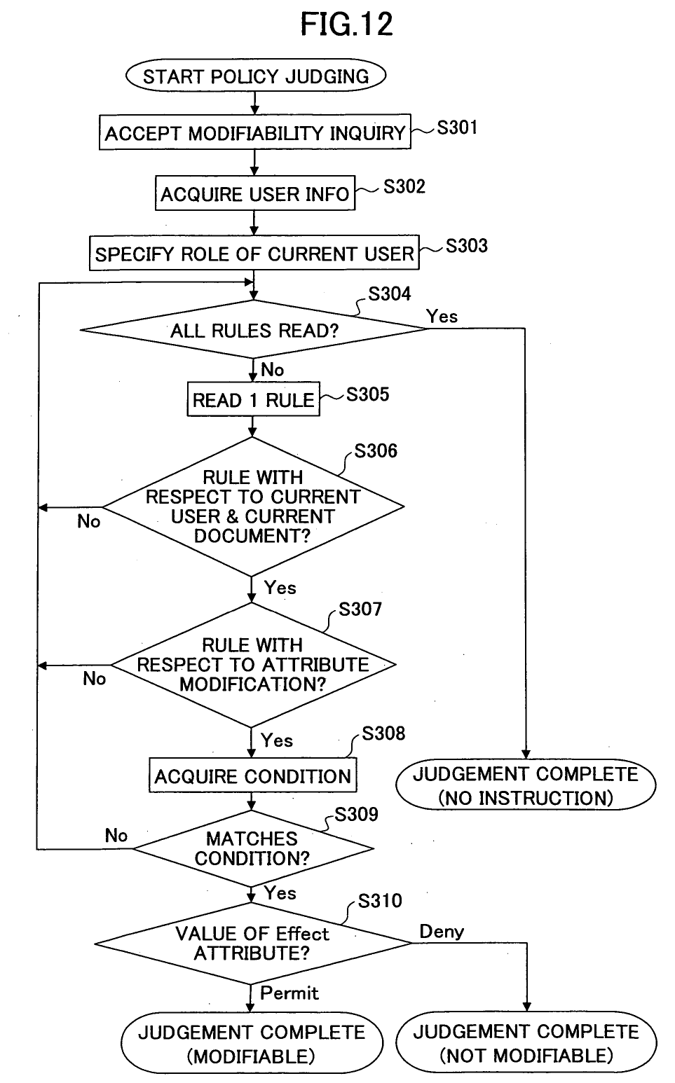

Next, a more detailed description will be given of the process (steps Sill through S116 shown in FIG. 9) that is carried out when the security service 11 receives the inquiry from the document profile service 12 inquiring the modifiability of the value of the target attribute. FIG. 12 is a flow chart for explaining the process of judging the modifiability of the value of the security attribute in the security service 11.

In a step S301 shown in FIG. 12, the inquiry that inquires the modifiability of the value of the target attribute is accepted by the document managing service 21. The accepted inquiry includes the ticket, the security attribute list, the security attribute ID of the target attribute, the value of the security attribute after the modification and the like, as the arguments. The process advances to a step S302 after the step S301, and requests the validity inspection of the ticket to the authenticating service 31, so as to acquire the user information of the current user (user ID, group ID, section and the like) from the authenticating service 31. The process advances to a step S303 after the step S302, and the role of the current user is specified based on the user information, the security attribute list and the like. For example, if the user ID of the current user matches the creator ID included in the attribute list of the current document, it is specified that the current user is the “creator” of the current document. In addition, if the section to which the current user belongs and the document managing section included in the security attribute list of the current document match, it is specified that the current user is the “participant” of the current document. Moreover, it is specified whether the current user is the “manager” or the “officer”, by making an inquiry to the server or the like that manages the information for specifying the manager or the officer.

Steps S304 through S307 following the step S303 are repeated until the rule definition shown in FIG. 6 that is to be applied is searched from the attribute modifying policy 112 shown in FIG. 6. In other words, the attribute modification judging part 113 reads one rule definition from the attribute policy 112 (step S205), and judges, based on the Subject definition and the Resource definition within the read Rule definition (hereinafter referred to as a “current Rule definition”), whether or not the current Rule definition is the definition with respect to the current user and the current document (step S306).

If the current Rule definition is the definition with respect to the current user and the current document, the attribute modification judging part 113 judges whether or not the current Rule definition is the definition with respect to the attribute modification, based on the Action definition within the current Rule definition (step S307). If the current Rule definition is the definition with respect to the attribute modification, the attribute modification judging part 113 acquires the Condition definition within the current Rule definition (step S308), and judges whether or not the requested modification satisfies the conditional expression or equation in the Condition definition (step S309). If the conditional expression or equation is satisfied, it may be judged that the current Rule definition is the security rule that is to be applied. Accordingly, the attribute modification judging part 113 selects the current Rule definition as the applying target, that is, the rule definition that is to be applied, and judges the modifiability of the value of the attribute according to the value of the Effect attribute within the current Rule definition (step S310). In other words, if the value of the Effect attribute is “Permit”, it is judged that the modification of the value of the attribute is permitted. On the other hand, if the value of the Effect attribute is “Deny”, it is judged that the modification of the value of the attribute is not permitted.

If the current Rule definition is not the definition with respect to the current user and the current document (NO in step S306) or, is not the definition with respect to the modification of the attribute (NO in step S307) or, does not match the conditional expression or equation in the Condition definition (NO in step S309), the attribute modification judging part 113 carries out the process of the step S304 and the subsequent steps so as to regard the next rule definition as the current definition. In addition, if none of the rule definitions in the attribute modifying policy 112 becomes the applying target (YES in step S304), the attribute modification judging part 113 regards the judgement result as being “indefinite”. Whether or not to interpret the judgement result “indefinite” as permitting the modification may be determined depending on the system operation. For example, in the document managing system 1 of this embodiment, the document profile service 12 may interpret the judgement result “indefinite” to mean “not permitted”, and notify this interpretation of the judgement result to the document managing service 21.

Therefore, according to the security server 10 of this embodiment, it is possible to finely control the modification of the values of the security attributes that are important from the security standpoint. In other words, it is possible to define a different security rule for each security attribute, and also define the security rule depending on (a) the combination of the value before the modification and the value after the modification, (b) the combination (a) in combination with the identity, and (c) the combinations (a) and (b) in combination with the conditional expression or equation. Accordingly, it is possible to prevent unauthorized modification of the value of the security attribute, and the security can be secured with respect to the modification of the security rule that is applied to the resource, even in a case where the access control is carried out according to a security policy having a higher abstraction unlike the conventional ACL.

In addition, according to the security server 10 of this embodiment, the security rule (attribute modifying policy 112) for the modification of the security attribute can be defined based on the same mechanisms (XACML or the like) as the security rule (document policy 111) related to the various kinds of operations with respect to the resources. For this reason, it is possible to implement a common program portion for interpretation with respect to the definition contents of the security rules, to thereby realize an efficient implementation of the program portion for the interpretation of the definitions.

Recently, CPUs are also mounted in embedded equipments that are specialized for special functions, and there are embedded equipments that realize the special functions by software, similarly to computers. For example, the so-called composite apparatuses or multi-function apparatuses correspond to such embedded equipments. The composite or multi-function apparatus is an image forming apparatus having a plurality of applications for realizing the functions of a printer, a copying apparatus, a facsimile apparatus and the like. There are cases where such composite or multi-function apparatuses require the security function.

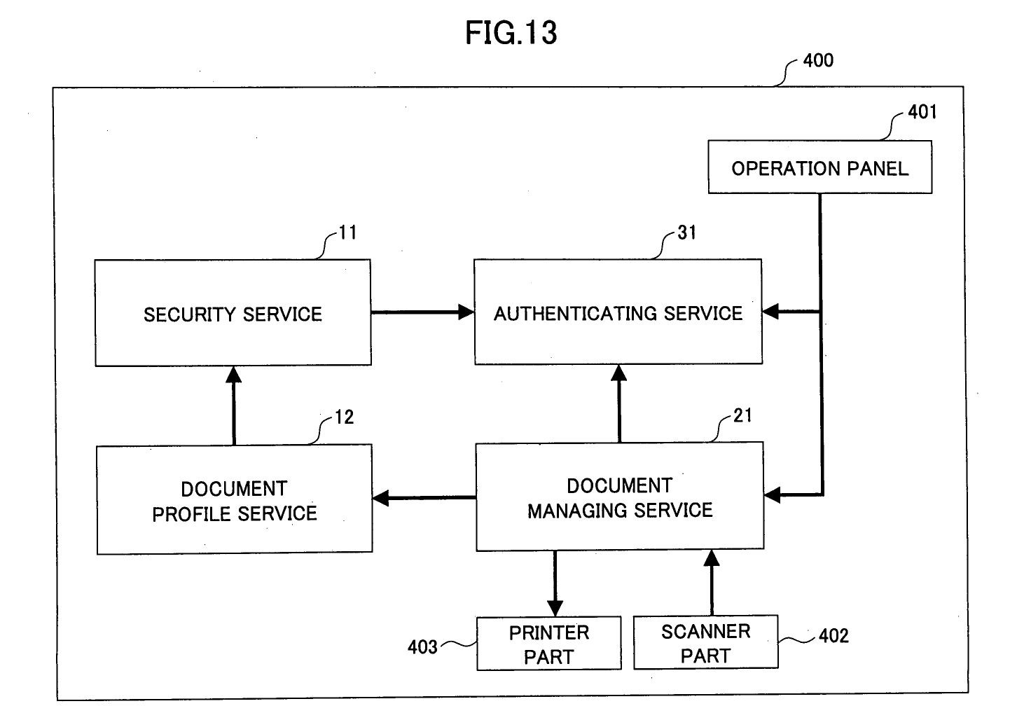

The present invention may also be applied to such equipments. FIG. 13 is a system block diagram showing a structure of an equipment implemented with various kinds of services of this embodiment of the present invention. In FIG. 13, those parts which are the same as those corresponding parts in FIG. 1 are designated by the same reference numerals, and a description thereof will be omitted.

In FIG. 13, an equipment 400 includes an operation panel 401, a scanner part 402, a printer part 403 and the like. The equipment 400 also includes a security service 11, a document profile service 12, a document managing service 21, an authenticating service 31 and the like. The equipment 400 has the security server 10, the document managing server 20 and the authenticating server 30 of the document managing system 1 shown in FIG. 1 that are implemented within a single housing of the equipment 400. In other words, the functions that are distributed in the case of the document managing system 1 shown in FIG. 1 are implemented within the single housing of the equipment 400.

The equipment 400 can manage the document that is read by the scanner part 402 in the document managing service 21, and print the document managed in the document managing service 21 by the printer part 403.

By employing such a structure for the equipment 400, it becomes possible to suitably control the operation to modify the security attribute of the document from the operation panel 401 or from the client application 41 (not shown) or the like that connects to the equipment 400 via a network.

This application claims the benefit of Japanese Patent Applications No. 2004-110001 filed Apr. 2, 2004 and No. 2005-036301 filed Feb. 14, 2005, in the Japanese Patent Office, the disclosure of which is hereby incorporated by reference.

Further, the present invention is not limited to these embodiments, but various variations and modifications may be made without departing from the scope of the present invention.

1. An information processing apparatus comprising:
a judging part configured to judge a modifiability of a value of an attribute of a resource that is an access target, based on definition information, said definition information defining a rule related to the modifiability of the value of the attribute depending on a combination of a value prior to the modification and a value after the modification, for the value of the attribute of the resource that is the access target.

2. The information processing apparatus as claimed in claim 1, further comprising:
a definition information managing part configured to manage the definition information.

3. The information processing apparatus as claimed in claim 1, wherein the definition information further defines the rule in combination with a category of an identity that modifies the value of the attribute.

4. The information processing apparatus as claimed in claim 1, wherein the definition information defines the rule depending on the combination of the value prior to the modification and the value after the modification, for the value of each of a plurality of attributes of the resource that is the access target.

5. The information processing apparatus as claimed in claim 1, wherein the attribute is used to judge whether or not a predetermined operation is permitted with respect to the resource that is the access target.

6. The information processing apparatus as claimed in claim 1, wherein:
the rule defines the value of the attribute of the resource that is the access target, as resource specifying information for specifying the resource that is the access target and to which the rule is applicable; and
said judging part applies to judging the modifiability the rule in which at least a value of the resource specifying information includes the value of the attribute of the resource that is the access target and is related said judging.

7. The information processing apparatus as claimed in claim 1, wherein:
the rule defines the value of the attribute of the resource that is the access target, as resource specifying information for specifying the resource that is the access target and to which the rule is applicable; and
said judging part applies to judging the modifiability the rule in which at least the resource specifying information includes the value after the modification of the attribute of the resource that is the access target and is related said judging.

8. The information processing apparatus as claimed in claim 1, wherein:
the rule defines identity specifying information to which the rule is applicable and that specifies a category of an identity that modifies the value of the attribute of the resource that is the access target; and
said judging part applies to judging the modifiability the rule in which at least the identity specifying information includes the category of the identity related to requesting said judging.

9. The information processing apparatus as claimed in claim 1, wherein:
the rule defines a conditional expression or equation for applying the rule; and
said judging part applies to judging the modifiability the rule in which the conditional expression or equation satisfying the modification related to said judging is defined.

10. The information processing apparatus as claimed in claim 1, wherein:
the rule defines permission identifying information indicating a judgement result for a case where the rule is applied to judging the modifiability; and
said judging part judges the modifiability based on the permission identifying information defined in the rule that is applied to said judging.

11. The information processing apparatus as claimed in claim 1, wherein the attribute of the resource that is the access target is a privacy level of the resource that is the access target.

12. The information processing apparatus as claimed in claim 1, wherein the attribute of the resource that is the access target is a state in a life cycle of the resource that is the access target.

13. The information processing apparatus as claimed in claim 3, wherein the identity is categorized according to a role related to the resource that is the access target.

14. The information processing apparatus as claimed in claim 1, wherein the definition information is represented based on extensible Access Control Markup Language (XACML).

15. The information processing apparatus as claimed in claim 1, further comprising:
a judgement result providing part configured to return a judgement result output from the judging part by controlling the judging part to judge the modifiability, in response to a request received via a network that requests judging the modifiability of the value of the attribute of the resource that is the access target.

16. A resource managing apparatus for managing a resource that becomes an access target, comprising:
a part configured to send the request that requests judging the modifiability of the attribute of the resource that is the access target, with respect to the information processing apparatus of claim 15; and
a part configured to judge the modifiability of the value of the attribute of the resource that is the access target, based on the judgement result that is returned from the information processing apparatus in response to the request.

17. An attribute modifiability judging method to be implemented by a computer, comprising:
a judgement request accepting procedure accepting a request that requests judging a modifiability of a value of an attribute of a resource that is an access target;
a definition information acquiring procedure acquiring definition information that defines rules related to judging the modifiability of the value of the attributes of the resources that may become the access target depending on a combination of a value prior to the modification and a value after the modification of the attribute of the resource that is the access target;
a rule selecting procedure selecting the rule corresponding to the request that requests judging the modifiability of the value of the attribute of the resource that is the access target, of the rules defined in the definition information acquired by the definition information acquiring procedure; and
a judging procedure judging the modifiability of the value of the attribute by applying the rule selected by the rule selecting procedure.

18. The attribute modifiability judging method as claimed in claim 17, wherein:
the rule defines the value of the attribute of the resource that is the access target, as resource specifying information for specifying the resource that is the access target and to which the rule is applicable; and
said rule selecting procedure selects the rule in which at least a value of the resource specifying information includes the value of the attribute of the resource that is the access target and is related to judging the modifiability of the value of the attribute value of the resource that is the access target is permitted.

19. The attribute modifiability judging method as claimed in claim 17, wherein:
the rule defines the value of the attribute of the resource that is the access target, as resource specifying information for specifying the resource that is the access target and to which the rule is applicable; and
said rule selecting procedure selects the rule in which at least the resource specifying information includes the value after the modification of the attribute of the resource that is the access target and is related to judging the modifiability of the value of the attribute value of the resource that is the access target is permitted.

20. The attribute modifiability judging method as claimed in claim 17, wherein:
the rule defines identity specifying information to which the rule is applicable and that specifies a category of an identity that modifies the value of the attribute of the resource that is the access target; and
said rule selecting procedure selects the rule in which at least the identity specifying information includes the category of the identity related to requesting judging the modifiability of the value of the attribute value of the resource that is the access target is permitted.

21. The attribute modifiability judging method as claimed in claim 17, wherein:
the rule defines a conditional expression or equation for applying the rule; and
said rule selecting procedure selects the rule in which the conditional expression or equation satisfying the modification related to judging the modifiability of the value of the attribute value of the resource that is the access target is permitted is defined.

22. The attribute modifiability judging method as claimed in claim 17, wherein:
the rule defines permission identifying information indicating a judgement result for a case where the rule is applied to judging the modifiability of the value of the attribute of the resource that is the access target; and
said judging procedure judges the modifiability based on the permission identifying information defined in the rule that is selected by said rule selecting procedure.

23. A computer-readable storage medium which stores a program for causing a computer to judge modifiability of an attribute, said program comprising:
a judgement request accepting procedure causing the computer to accept a request that requests judging a modifiability of a value of an attribute of a resource that is an access target;
a definition information acquiring procedure causing the computer to acquire definition information that defines rules related to judging the modifiability of the value of the attributes of the resources that may become the access target depending on a combination of a value prior to the modification and a value after the modification of the attribute of the resource that is the access target;
a rule selecting procedure causing the computer to select the rule corresponding to the request that requests judging the modifiability of the value of the attribute of the resource that is the access target, of the rules defined in the definition information acquired by the definition information acquiring procedure; and
a judging procedure causing the computer to judge the modifiability of the value of the attribute by applying the rule selected by the rule selecting procedure.

24. The computer-readable storage medium as claimed in claim 23, wherein:
the rule defines the value of the attribute of the resource that is the access target, as resource specifying information for specifying the resource that is the access target and to which the rule is applicable; and
said rule selecting procedure causes the computer to select the rule in which at least a value of the resource specifying information includes the value of the attribute of the resource that is the access target and is related to judging the modifiability of the value of the attribute value of the resource that is the access target is permitted.

25. The computer-readable storage medium as claimed in claim 23, wherein:
the rule defines the value of the attribute of the resource that is the access target, as resource specifying information for specifying the resource that is the access target and to which the rule is applicable; and
said rule selecting procedure causes the computer to select the rule in which at least the resource specifying information includes the value after the modification of the attribute of the resource that is the access target and is related to judging the modifiability of the value of the attribute value of the resource that is the access target is permitted.

26. The computer-readable storage medium as claimed in claim 23, wherein:
the rule defines identity specifying information to which the rule is applicable and that specifies a category of an identity that modifies the value of the attribute of the resource that is the access target; and
said rule selecting procedure causes the computer to select the rule in which at least the identity specifying information includes the category of the identity related to requesting judging the modifiability of the value of the attribute value of the resource that is the access target is permitted.

27. The computer-readable storage medium as claimed in claim 23, wherein:
the rule defines a conditional expression or equation for applying the rule; and
said rule selecting procedure causes the computer to select the rule in which the conditional expression or equation satisfying the modification related to judging the modifiability of the value of the attribute value of the resource that is the access target is permitted is defined.

28. The computer-readable storage medium as claimed in claim 23, wherein:
the rule defines permission identifying information indicating a judgement result for a case where the rule is applied to judging the modifiability of the value of the attribute of the resource that is the access target; and
said judging procedure causes the computer to judge the modifiability based on the permission identifying information defined in the rule that is selected by said rule selecting procedure.
